(19) United States
(12) Patent Application Publication
(10) Pub. No.: US 2026/0280181 A1
(43) Pub. Date: Sep. 17, 2026

(54) CONNECTOR

(71) Applicant: HOSIDEN CORPORATION, OSAKA (JP)

(72) Inventor: Takahide KAWANISHI, Osaka (JP)

(21) Appl. No.: 19/548,015

(22) Filed: Feb. 24, 2026

(30) Foreign Application Priority Data
Mar. 17, 2025 (JP) 2025-042345

(51) Int. Cl. H01R 13/52; H01R 13/504; H01R 13/6597; H01R 24/40; H01R 103/00

(52) U.S. Cl. CPC H01R 13/521; H01R 13/504; H01R 13/6597; H01R 24/40; H01R 2103/00

(57) ABSTRACT

A connector 100 includes: a bar-shaped terminal 61; a holder 62 into which the terminal 61 is inserted; a tubular shell 63 fitted onto the holder 62; and a shield member 65 in contact with the tubular shell 63; a housing 10 in intimate contact with the shield member 65; and an outer seal member 66 fitted onto the tubular shell 63. The tubular shell 63 has a tubular body section 63a covering the holder 62 and a first flange section 63b. The shield member 65 has a connection section 65b electrically connected to the first flange section 63b. The outer seal member 66 has a first outer protrusion 66a elastically deformed and in intimate contact with the shield member 65, a second outer protrusion 66b in intimate contact with the housing 10, and a first inner protrusion 66c and a second inner protrusion 66d in intimate contact with the tubular shell 63.

### BACKGROUND OF THE INVENTION

### 1. Field of the Invention

The present disclosure relates to a connector.

### 2. Description of the Related Art

Patent Document 1 (JP 2015-026568A) describes a connector (an electronic device module in Patent Document 1) to be applied to a camera module. In this connector, an image sensor is housed inside a metal case constituted by a case body and a cover member, and a connector terminal for external device connection is connected to the image sensor. The connector terminal for external device connection is surrounded by a metal ground shell. The ground shell is electrically connected to, and fixed to, the case body. Also, the ground shell is surrounded by an outer housing.

An annular first waterproof member made of rubber or the like is disposed between the ground shell and the outer housing. Also, an annular second waterproof member made of rubber or the like is disposed between the case body and the cover member. Furthermore, a seal section formed by potting is disposed between the case body and the outer housing, and another seal section formed by potting is also disposed between the ground shell and the connector terminal for external device connection. This configuration suppresses ingress of moisture or the like into the interior of the connector.

### SUMMARY OF THE INVENTION

In the connector described in Patent Document 1, the first waterproof member, the second waterproof member, and the potting at two locations suppress ingress of moisture or the like into the interior. Thus, the number of components increases, and the number of person-hours required to manufacture the connector also increases. As a result, the connector has a very high-cost structure, leaving room for improvement.

To address this, there is a need for a connector capable of suppressing moisture ingress or the like with a simple and inexpensive configuration.

One embodiment of a connector according to the present disclosure is a connector to which a coaxial cable is electrically connectable, and includes: a bar-shaped terminal having electrical conductivity and electrically connectable to an internal conductor of the coaxial cable; an insulating holder supporting the terminal inserted therein, in such a manner as to be coaxial with an axis of the terminal; an electrically conductive tubular shell fitted onto the holder in such a manner as to be coaxial with the axis and electrically connectable to an external conductor of the coaxial cable, the tubular shell having: a tubular body section covering the holder; and an annular first flange section extending radially outward from the tubular body section; an electrically conductive shield member in contact with the tubular shell and configured to block an external electromagnetic wave, the shield member having a cylindrical shape demarcating a through-hole through which the tubular body section passes, and having a connection section in contact with and electrically connected to the first flange section; an insulating housing disposed in intimate contact with the shield member; and an insulating outer seal member fitted onto the tubular shell and configured to suppress ingress of water into the shield member, the outer seal member having: a first outer protrusion and a second outer protrusion each having an annular shape and protruding radially outward, and a first inner protrusion and a second inner protrusion each having an annular shape and protruding radially inward, wherein the outer seal member is elastically deformed in a radial direction in such a manner that the first outer protrusion is in intimate contact with the shield member, the second outer protrusion is in intimate contact with the housing, and the first inner protrusion and the second inner protrusion are in intimate contact with the tubular shell.

According to the present embodiment, the outer seal member fitted onto the tubular shell includes the first outer protrusion, the first inner protrusion, the second outer protrusion, and the second inner protrusion. The outer seal member elastically deforms in the radial direction such that the first outer protrusion comes into intimate contact with the shield member, and the second outer protrusion comes into intimate contact with the housing. In addition, both the first inner protrusion and the second inner protrusion of the outer seal member come into intimate contact with the tubular shell. In this manner, by providing the outer seal member, the connector of the present embodiment can suppress moisture that has entered through a gap between the housing and the tubular shell from proceeding to and entering the opposite side of the tubular shell and the shield member. Furthermore, by providing the outer seal member, moisture that has entered from the opposite direction, i.e., from a gap between the tubular shell and the shield member can be prevented from proceeding to and entering the housing and the opposite side of the tubular shell. Thus, the connector according to the present embodiment enables suppression of moisture ingress or the like with a simple and inexpensive configuration.

In another embodiment of the connector according to the present disclosure, the housing has a support surface perpendicular to the axis, and the outer seal member is disposed in a state of being compressed and elastically deformed by the first flange section and the support surface along an extension direction of the axis.

According to the present embodiment, the housing has the support surface perpendicular to the axis, and the outer seal member is disposed while being compressed and elastically deformed by the first flange section and the support surface along the extension direction of the axis. Therefore, even if the outer seal member repeatedly expands and contracts under high-temperature and low-temperature conditions, intimate contact of the outer seal member with the shield member, the housing, and the tubular shell can be maintained. In addition, even if the connection section loosens, the restoring force of the outer seal member supported by the support surface acts in a direction pressing the first flange section, thereby allowing the first flange section to be constantly pressed against the connection section. Thus, the electrical connection between the tubular shell and the shield member can be maintained. As a result, stable shielding characteristics can be achieved.

In another embodiment of the connector according to the present disclosure, the shield member has: a first annular section having an annular shape and demarcating a portion of the through hole, and a second annular section having an annular shape, disposed closer to the connection section in an extension direction of the axis than the first annular section, and having an outer diameter smaller than an outer diameter of the first annular section, and the housing is in intimate contact with at least an outer side surface of the first annular section and an outer side surface of the second annular section.

According to the present embodiment, the housing is in intimate contact with at least the outer surface of the first annular section of the shield member and the outer surface of the second annular section having a smaller diameter than the first annular section. Thus, the shield member is held with respect to the housing, and there is no concern about detachment. In addition, even when the coaxial cable is pulled out, there is no concern about detachment of the housing from the shield member.

In another embodiment of a connector according to the present disclosure, the shield member has a cutout section, and the housing is in intimate contact with the cutout section.

According to the present embodiment, the housing is in intimate contact with the cutout section of the shield member, thereby preventing the shield member from moving in a rotational direction about the axis relative to the housing.

In another embodiment of the connector according to the present disclosure, the shield member has: an annular lock section protruding radially inward relative to an annular inner peripheral surface of the connection section, and a connection crimp section on the annular inner peripheral surface of the connection section, and the first flange section of the tubular shell is electrically connected to the shield member by being clamped by the lock section and the connection crimp section.

According to the present embodiment, the first flange section of the tubular shell is held between the lock section of the shield member and a connection crimp section. Thus, compared with methods such as welding, the tubular shell can be fixed to the shield member with fewer person-hours, and the electrical connection between the shield member and the tubular shell can be ensured.

In another embodiment of the connector according to the present disclosure, the tubular shell has: a step section in which a tubular inner peripheral surface of the tubular body section has an expanded diameter in a vicinity of the first flange section, and a hold crimp section on the tubular inner peripheral surface of the tubular body section, and the holder is held by the tubular shell by being clamped by the step section and the hold crimp section.

According to the present embodiment, the holder is held between the hold crimp section and the step section formed by expanding the diameter of the tubular inner peripheral surface of the tubular body section of the tubular shell. This allows the holder to be fixed to the tubular shell with fewer person-hours.

In another embodiment of a connector according to the present disclosure, the connector further includes an inner seal member elastically deformed and disposed in intimate contact with a tubular inner peripheral surface of the tubular body section and an outer peripheral surface of the terminal.

According to the present embodiment, the inner seal member is elastically deformed and disposed in such a manner as to come into intimate contact with the tubular inner peripheral surface of the tubular body section and the outer peripheral surface of the terminal. Thus, moisture that has entered from the terminal exposed within the tubular shell or from the tubular inner peripheral surface of the tubular shell can be prevented from proceeding to and entering the opposite side of the tubular shell, the terminal, and the holder.

### BRIEF DESCRIPTION OF THE DRAWINGS

FIG. 1 is a perspective view of a connector according to the present embodiment.

FIG. 2 is a cross-sectional view taken along line II-II of FIG. 1.

FIG. 3 is an exploded perspective view of the connector.

FIG. 4 is an exploded perspective view of the connector.

### DETAILED DESCRIPTION OF PREFERRED EMBODIMENTS

Hereinafter, an embodiment of a connector according to the present disclosure will be described in detail with reference to the drawings. Note that the embodiment described below is provided as an example for illustrating the connector according to the present disclosure and are not intended to limit the connector to the embodiment alone. Therefore, the connector according to the present disclosure may be implemented in various forms without departing from the spirit of the present disclosure.

In the present embodiment, the connector 100 is provided as part of a camera unit (an in-vehicle camera; not shown) mounted on a vehicle. The camera unit may also be used for applications other than vehicles, for example, bicycles, drones, and the like. The camera unit can be electrically connected to a monitor device (not shown) or an in-vehicle electronic control unit (ECU) via a coaxial cable (not shown).

The coaxial cable is a communication cable that transmits high-frequency signals. The coaxial cable is by coaxially arranging an internal conductor (not shown), which is formed from a bundle of copper wires, and an external conductor (not shown), which is formed from a mesh of copper wires covering the periphery of the internal conductor, with a dielectric (insulator) interposed therebetween. The external conductor functions as a shield that prevents leakage of high-frequency signals and ingress of radio waves from the outside.

The coaxial cable outputs high-frequency signals generated by the camera unit to the monitor device or the in-vehicle ECU. The coaxial cable also supplies electric power from the monitor device or the in-vehicle ECU to the camera unit. A plug is connected to a leading end of the coaxial cable, and the coaxial cable and the connector 100 are electrically connected via the plug.

### Configuration of Connector

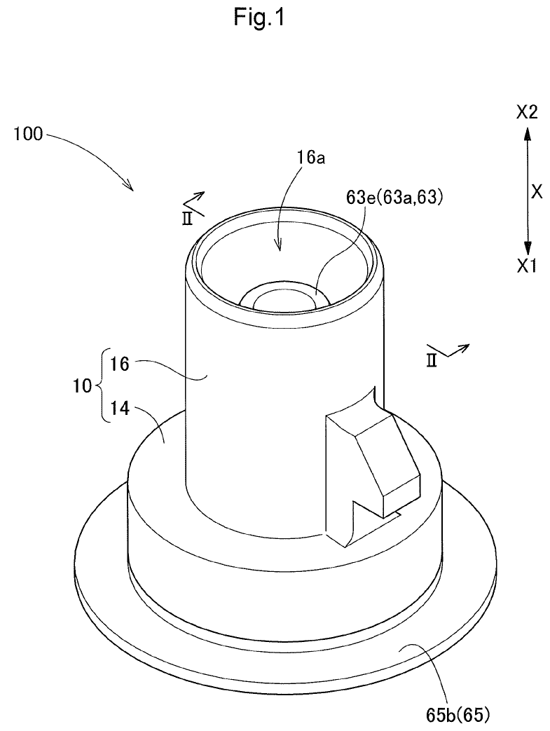

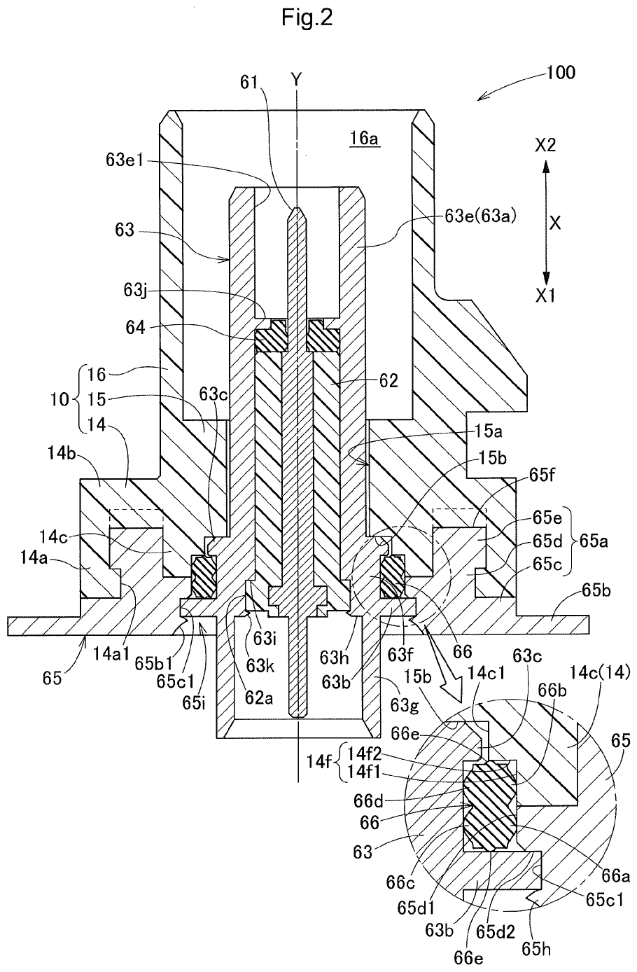

A configuration of the connector 100 according to the present embodiment will be described with reference to FIGS. 1 to 4. The connector 100 includes a housing 10, a signal terminal 61 (an example of a terminal), a holder 62, a tubular shell 63, a first seal member 64 (an example of an inner seal member), a shield member 65, and a second seal member 66 (an example of an outer seal member). In the following description, in FIG. 2, the direction or side from which the flange section 65b of the shield member 65 is viewed from the housing 10 is referred to as the X1 direction or X1 side. The opposite direction or side is referred to as the X2 direction or X2 side. The X1 direction and the X2 direction are collectively referred to as the X direction.

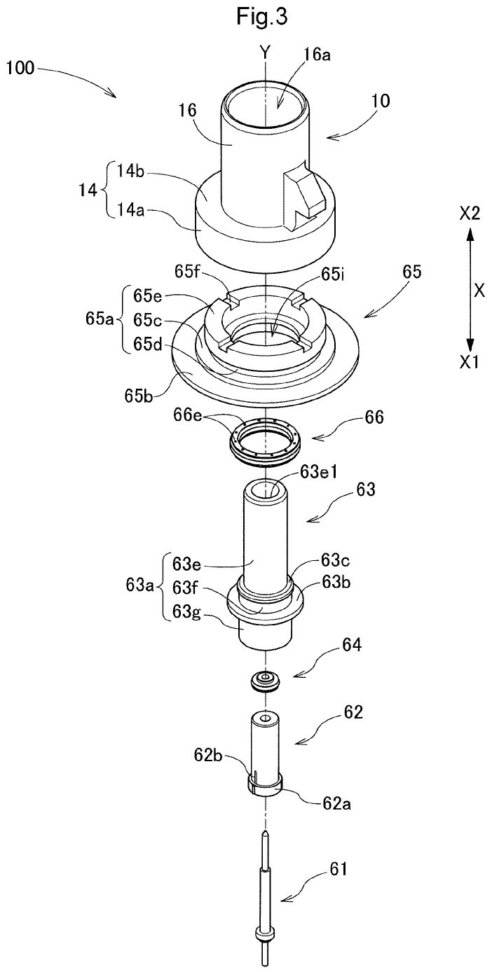

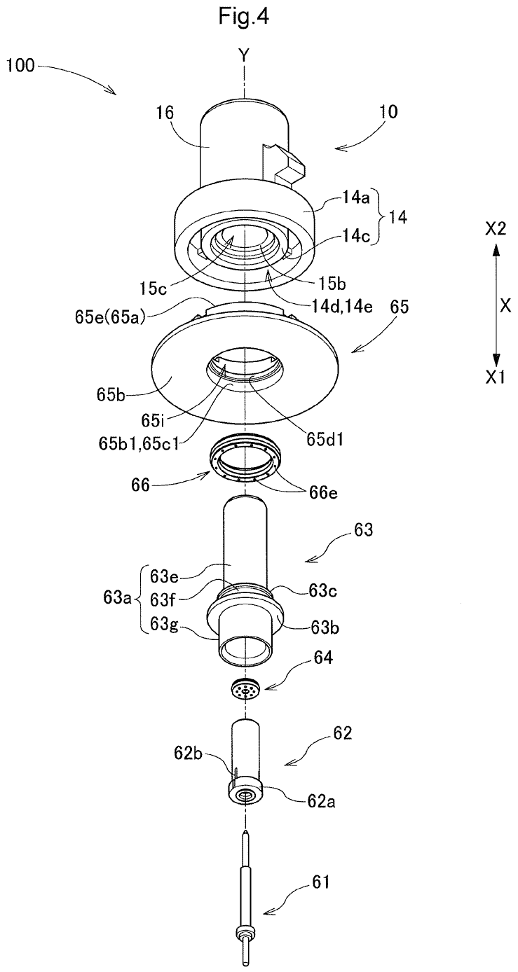

The housing 10 is made of an insulating material such as resin, and includes a bottomed cylindrical base section 14 and a cylindrical fitting section 16 extending from the base section 14 in the X2 direction, as shown in FIGS. 3 and 4. The outer diameter of the base section 14 is larger than the outer diameter of the fitting section 16 in a view taken along the X direction (hereinafter also referred to as a plan view). Hereinafter, a center axis Y refers to an axis passing through the center of the base section 14 and parallel to the X direction in a plan view.

The base section 14 has a first tubular wall 14a having a cylindrical shape, a first plate-shaped wall 14b having a plate shape, and a second tubular wall 14c having a cylindrical shape. An opening 14d refers to an X1-side end portion of the first tubular wall 14a. An internal space 14e refers to a space connected to the opening 14d and demarcated by the first tubular wall 14a and the first plate-shaped wall 14b (see FIG. 4). The second tubular wall 14c is disposed in the internal space 14e.

As shown in FIGS. 2 to 4, the first tubular wall 14a of the base section 14 has, at its X1-side end portion (the opening 14d), an annular holding section 14a1 having an inner diameter relatively smaller than the inner diameter on the X2 side of the first tubular wall 14a. The second tubular wall 14c protrudes in the X1 direction from an X1-side surface of the first plate-shaped wall 14b in the internal space 14e. The second tubular wall 14c is entirely housed within the internal space 14e and does not protrude to the X1 side beyond the opening 14d.

The second tubular wall 14c has a first inner peripheral surface 14c1, whose X1-side end portion is cut out over the entire circumference radially outward and toward the X2-side, forming a recess 14f (see FIG. 2). The recess 14f has a first recess surface 14f1 having an inner diameter larger than that of the first inner peripheral surface 14c1 and having a circular sectional shape perpendicular to the center axis Y, and a second recess surface 14f2 (an example of a support surface) having an annular shape perpendicular to the first recess surface 14f1. The first recess surface 14f1 is parallel to the center axis Y, and the second recess surface 14f2 is perpendicular to the center axis Y.

As shown in FIG. 2, the fitting section 16 extends in the X2 direction from the first plate-shaped wall 14b of the base section 14. A cylindrical insertion section 15 extends from the vicinity of an X1-side end portion of an internal space 16a to the vicinity of an X2-side end portion of the second tubular wall 14c disposed in the internal space 14e. The internal space 16a of the fitting section 16 is connected to the internal space 14e of the base section 14 through an internal space 15c of the insertion section 15. The insertion section 15 is formed integrally with the base section 14 and the fitting section 16. The tubular shell 63 is inserted into the insertion section 15. That is to say, the inner diameter of the insertion section 15 is slightly larger than the outer diameter of the tubular shell 63 and smaller than the inner diameter of the fitting section 16 and the inner diameter of the second tubular wall 14c. Thus, a first step 15b is formed between the first inner peripheral surface 14c1 of the second tubular wall 14c and a second inner peripheral surface 15a of the insertion section 15.

The signal terminal 61 has a bar shape and is made of a conductive metal or the like. The axis of the signal terminal 61 is disposed along the X direction, coaxially with the center axis Y of the housing 10. That is to say, the extension direction of the axis is parallel to the X direction. The signal terminal 61 has an X1-side end portion that is electrically connectable to a camera module of the camera unit, and an X2-side end portion that is electrically connectable to the internal conductor of the coaxial cable via the plug.

The holder 62 is made of resin and is disposed on an outer peripheral surface of an intermediate portion, in the X direction, of the signal terminal 61. The holder 62 is formed by insert molding and is integrated with the signal terminal 61. In other words, the signal terminal 61 is inserted into and supported by the holder 62. The holder 62 has a cylindrical shape with the signal terminal 61 passing through its center. The holder 62 has, near its X1-side end portion, an integrally formed stopper 62a having an outer diameter relatively larger than that of the other portions of the holder 62. The holder 62 also has, on its outer peripheral surface, press-fit sections 62b extending from the stopper 62a toward the X2 direction (see FIGS. 3 and 4). Four press-fit sections 62b are evenly arranged along the circumferential direction of the holder 62. The press-fit sections 62b serve as a press-fit allowance for press-fitting the holder 62 into the tubular shell 63.

The tubular shell 63 is made of a conductive metal and is electrically connectable to the external conductor of the coaxial cable. The tubular shell 63 is fitted onto the holder 62. In other words, the holder 62 is inserted (internally fitted) into the tubular shell 63 and thus held. The tubular shell 63 is disposed coaxially with the center axis Y inside the housing 10 such that it extends from the X1 side of the base section 14 through the internal space 15c of the insertion section 15 to the internal space 16a of the fitting section 16.

The tubular shell 63 includes a tubular body section 63a having a substantially cylindrical shape, a first flange section 63b having an annular plate shape and extending radially outward from the tubular body section 63a, and a second flange section 63c that has an annular plate shape, extends radially outward from the tubular body section 63a, and is disposed on the X2 side of the first flange section 63b. The tubular body section 63a covers the outer periphery of the holder 62. The tubular body section 63a has an X1-side end portion protruding to the X1 side beyond the internal space 14e of the base section 14 of the housing 10, an intermediate portion inserted into the insertion section 15 and radially opposed thereto, and an X2-side end portion positioned within the internal space 16a of the fitting section 16. The first flange section 63b and the second flange section 63c extend radially outward from the outer peripheral surface of the tubular body section 63a in a direction perpendicular to the X direction. The outer diameter of the first flange section 63b is larger than that of the second flange section 63c. A C-chamfer is formed over the entire circumference of an X2-side outer edge of the second flange section 63c. The first flange section 63b and the second flange section 63c of the tubular shell 63 are located within the internal space 14e of the base section 14 of the housing 10. Here, an X1-side surface of the second flange section 63c and the second recess surface 14f2 of the housing 10 are located at the same position in the X direction.

The tubular body section 63a has a small-diameter section 63e to which the plug can be connected, a first large-diameter section 63f that is disposed on the X1 side of the small-diameter section 63e and has an outer diameter larger than that of the small-diameter section 63e, and a second large-diameter section 63g that is disposed on the X1 side of the first large-diameter section 63f and has an outer diameter equal to that of the first large-diameter section 63f. The length of the small-diameter section 63e in the X direction is longer than the length of the second large-diameter section 63g in the X direction.

The length of the second large-diameter section 63g in the X direction is shorter than the length of the small-diameter section 63e in the X direction, and is longer than the length of the first large-diameter section 63f in the X direction. An X2-side surface of the second flange section 63c is located at the position in the X direction of the boundary between outer peripheral surfaces of the small-diameter section 63e and the first large-diameter section 63f. An X1-side surface of the first flange section 63b is located at the position in the X direction of the boundary between outer peripheral surfaces of the first large-diameter section 63f and the second large-diameter section 63g. Accordingly, in the X direction, the first large-diameter section 63f extends from the X2-side surface of the second flange section 63c to the X1-side surface of the first flange section 63b.

The inner diameter of the second large-diameter section 63g is larger than the inner diameter of the first large-diameter section 63f, and a second step 63h is formed at the boundary therebetween (see FIG. 2). In the X direction, the second step 63h is located at the same position as the X1-side surface of the first flange section 63b. The second step 63h is a location where riveting is performed to hold the holder 62 inside the tubular shell 63.

Also, in the X direction, a third inner peripheral surface 63e1 (an example of a tubular inner peripheral surface) of the small-diameter section 63e extends to an intermediate portion of the first large-diameter section 63f, and then expands in diameter at an intermediate portion of the first large-diameter section 63f in the vicinity of the first flange section 63b. This expanded diameter forms a third step 63i (an example of a step section). The stopper 62a of the holder 62 abuts the third step 63i to be locked at the third step 63i, thereby determining the position of the holder 62 (the signal terminal 61) in the X direction relative to the tubular shell 63. The length (distance) between the second step 63h and the third step 63i in the X direction is slightly longer than the length of the stopper 62a of the holder 62. Thus, with the holder 62 engaged, riveting can be performed by crushing the entire periphery of the inner edge of the second step 63h radially inward to form a first crimp section 63k (an example of a hold crimp section). As a result, the holder 62 is fixed to the tubular shell 63 and prevented from coming off in the X1 direction. That is to say, the holder 62 is clamped between the third step 63i and the first crimp section 63k and held inside the tubular shell 63. Note that, as long as the holder 62 does not come off the tubular shell 63 in the X1 direction, the first crimp section 63k may be formed discretely in the circumferential direction rather than over the entire circumference of the second step 63h. As described above, the connector 100 is configured such that the holder 62 is fixed to the tubular shell 63 by performing riveting to form the first crimp section 63k and clamping the holder 62 between the first crimp section 63k and the third step 63i. Therefore, the holder 62 can be reliably fixed to the tubular shell 63 with fewer person-hours.

The tubular shell 63 has a plate-shaped support section 63j having a central hole through which the signal terminal 61 can be inserted. The support section 63j extends radially inward from the third inner peripheral surface 63e1 of the small-diameter section 63e of the tubular body section 63a. The first seal member 64 is disposed on the X1 side of the support section 63j in such a manner as to be in contact with an X1-side surface and an inner peripheral surface of a hole of the support section 63j.

The first seal member 64 is made of an elastic material such as rubber and has a substantially annular plate shape with a central hole formed along the X direction through which the signal terminal 61 can be inserted. The holder 62 is disposed on the X1 side of the first seal member 64. The outer diameter of portions of the holder 62 other than the stopper 62a is substantially the same as the outer diameter of the first seal member 64. The signal terminal 61 is exposed through the hole of the support section 63j (the hole of the first seal member 64) on the X2 side of the support section 63j of the tubular shell 63. The first seal member 64 has a side surface that is elastically deformed to be in intimate contact with the third inner peripheral surface 63e1 of the small-diameter section 63e of the tubular body section 63a. The hole of the first seal member 64 is also elastically deformed to be in intimate contact with an outer peripheral surface of the signal terminal 61. The provision of the first seal member 64 can prevent ingress of moisture or the like from the X2 side of the signal terminal 61, which is exposed inside the tubular shell 63, into the connector 100.

The shield member 65 is made of a metal such as an aluminum alloy. As shown in FIG. 2, the shield member 65 is in intimate contact with an inner wall surface demarcating the internal space 14e of the base section 14 of the housing 10. Specifically, the shield member 65 is in intimate contact with an inner peripheral surface of the first tubular wall 14a, the X1-side surface of the first plate-shaped wall 14b, and an outer peripheral surface and an X1-side surface of the second tubular wall 14c of the housing 10. Hereinafter, portions of the shield member 65 that are in contact with the housing 10 are collectively referred to as a housing contact section 65a. The shield member 65 also has a flange section 65b (an example of a connection section) adjacent to the housing contact section 65a on the X1 side. The flange section 65b is not in intimate contact with the housing 10. The shield member 65 has a cylindrical shape and demarcates a through-hole 65i extending from the housing contact section 65a to the flange section 65b (see FIGS. 3 and 4). Any cross-section of the through-hole 65i perpendicular to the X direction is circular, and the center of the circle is located on the center axis Y.

As shown in FIGS. 2 and 3, the housing contact section 65a includes, in order from the X2 side toward the X1 side, an upper annular section 65e (an example of a first annular section), an intermediate annular section 65d (an example of a second annular section), and a lower annular section 65c. The upper annular section 65e, the intermediate annular section 65d, and the lower annular section 65c each have an annular shape demarcating a portion of the through-hole 65i, and the center of each of these annular sections is coaxial with the center axis Y.

The outer diameter of the lower annular section 65c is the same as the outer diameter of the first tubular wall 14a of the base section 14 of the housing 10. The lower annular section 65c has a fourth inner peripheral surface 65c1, whose inner diameter is slightly larger than the outer diameter of the first flange section 63b of the tubular shell 63 and allows the first flange section 63b to be smoothly inserted.

The outer diameter of the intermediate annular section 65d is smaller than the outer diameter of the lower annular section 65c. The intermediate annular section 65d has two different inner diameters. The intermediate annular section 65d has a fifth inner peripheral surface 65d1 on the X1 side whose inner diameter is smaller than the inner diameter of the lower annular section 65c and is the same as the inner diameter of the first recess surface 14f1 of the second tubular wall 14c of the housing 10. Thus, a fourth step 65d2 (an example of a lock section) is formed at the boundary between the fourth inner peripheral surface 65c1 of the lower annular section 65c and the fifth inner peripheral surface 65d1 of the intermediate annular section 65d. That is to say, the fourth step 65d2 is disposed radially inward of the fourth inner peripheral surface 65c1. The first flange section 63b of the tubular shell 63 is locked at the fourth step 65d2, thereby determining the position of the tubular shell 63 relative to the shield member 65. The inner diameter on the X2 side of the intermediate annular section 65d is larger than the inner diameter of the lower annular section 65c and is the same as the outer diameter of the second tubular wall 14c of the housing 10.

The outer diameter of the upper annular section 65e is smaller than the outer diameter of the lower annular section 65c and larger than the outer diameter of the intermediate annular section 65d. The inner diameter of the upper annular section 65e is larger than the inner diameters of the fourth inner peripheral surface 65c1 and the fifth inner peripheral surface 65d1, and is the same as the outer diameter of the second tubular wall 14c of the housing 10. That is to say, the inner diameter from the X2 side of the intermediate annular section 65d to the upper annular section 65e is the same as the outer diameter of the second tubular wall 14c of the housing 10. Furthermore, a plurality of (four in the present embodiment) recessed grooves 65f (each of which is an example of a cutout section) are formed on an X2-side surface of the upper annular section 65e by cutting inward in the X1 direction (see FIG. 3). The recessed grooves 65f are formed radially and arranged at 90-degree intervals along the circumferential direction of the upper annular section 65e.

The flange section 65b has an annular plate shape. The outer diameter of the flange section 65b is larger than the outer diameter of the lower annular section 65c. The flange section 65b has a sixth inner peripheral surface 65b1 (an example of an annular inner peripheral surface), whose inner diameter is the same as the inner diameter of the fourth inner peripheral surface 65c1 of the lower annular section 65c of the shield member 65 (see FIG. 4). Accordingly, the sixth inner peripheral surface 65b1 and the fourth inner peripheral surface 65c1 form one smoothly connected inner peripheral surface, and the fourth step 65d2 protrudes radially inward from the sixth inner peripheral surface 65b1 (see FIG. 2). The inner diameters of the sixth inner peripheral surface 65b1 and the fourth inner peripheral surface 65c1 are slightly larger than the outer diameter of the first flange section 63b of the tubular shell 63, allowing the first flange section 63b to be smoothly inserted.

As shown in FIG. 2, an X1-side edge of the sixth inner peripheral surface 65b1 of the flange section 65b is crushed radially inward, forming a second crimp section 65h (an example of a connection crimp section). The first flange section 63b of the tubular shell 63 is clamped between the second crimp section 65h and the fourth step 65d2, and is thereby fixed to the shield member 65. The tubular shell 63 and the shield member 65 are thus connected electrically.

The connector 100 of the present embodiment is configured such that the tubular shell 63 is fixed to and electrically connected with the shield member 65 by forming the second crimp section 65h and clamping the first flange section 63b between the second crimp section 65h and the fourth step 65d2. Thus, the tubular shell 63 can be reliably fixed to the shield member 65 with fewer person-hours to achieve electrical conduction between the tubular shell 63 and the shield member 65, compared to welding or similar methods.

The second seal member 66 is made of an elastic material such as rubber and has a substantially annular plate shape with a through-hole formed at the center along the X direction. The second seal member 66 has two protrusions arranged along the X direction on an outer side surface, and also has two protrusions arranged along the X direction on an inner side surface. Hereinafter, of the two protrusions on the outer side surface, a protrusion on the X1 side is referred to as a first outer protrusion 66a, and a protrusion on the X2 side is referred to as a second outer protrusion 66b. Also, of the two protrusions on the inner side surface, a protrusion on the X1 side is referred to as a first inner protrusion 66c, and a protrusion on the X2 side is referred to as a second inner protrusion 66d. The second seal member 66 also has a plurality of (twelve in the present embodiment) projections 66e formed on each of its X1-side and X2-side surfaces (see FIGS. 2 to 4). The length (thickness) of the second seal member 66 in the X direction is slightly longer than the distance between an X2-side surface of the first flange section 63b of the tubular shell 63 and the second recess surface 14f2 of the recess 14f of the housing 10. The length (thickness) of the second seal member 66 in the X direction refers to the distance between an apex of a projection 66e formed on the X1-side surface and an apex of a projection 66e formed on the X2-side surface.

The first outer protrusion 66a and the first inner protrusion 66c are disposed at the same position in the X direction, and the second outer protrusion 66b and the second inner protrusion 66d are also disposed at the same position in the X direction. Further, the first outer protrusion 66a and the second outer protrusion 66b have the same outermost diameter (the diameter at the protrusion apex), and the first inner protrusion 66c and the second inner protrusion 66d have the same innermost diameter (the diameter at the protrusion apex).

The connector 100 of the present embodiment is configured such that the second seal member 66 is fitted onto a portion of the tubular shell 63 between the X2-side surface of the first flange section 63b and the X1-side surface of the second flange section 63c. As mentioned above, the length of the second seal member 66 in the X direction is slightly longer than the distance between the X2-side surface of the first flange section 63b of the tubular shell 63 and the second recess surface 14f2 of the recess 14f of the housing 10. Consequently, the second seal member 66 is compressed in the X direction and elastically deformed while being fitted to the tubular shell 63 and the housing 10. Here, the apexes of the projections 66e formed on the X2-side surface are in intimate contact with the second recess surface 14f2 of the recess 14f of the housing 10, and the apexes of the projections 66e formed on the X1-side surface are in intimate contact with the X2-side surface of the first flange section 63b (see FIG. 2).

The second seal member 66 is installed while being elastically deformed in the radial direction. In this state, the first outer protrusion 66a is in intimate contact with the fifth inner peripheral surface 65d1 of the intermediate annular section 65d of the shield member 65, and the second outer protrusion 66b is in intimate contact with the first recess surface 14f1 of the recess 14f of the second tubular wall 14c of the housing 10. Both the first inner protrusion 66c and the second inner protrusion 66d are in intimate contact with the outer peripheral surface of the first large-diameter section 63f of the tubular shell 63.

### Operation and Effects of the Connector

The connector 100 of the present embodiment includes the first seal member 64. The side surface of the first seal member 64 is elastically deformed and in intimate contact with the third inner peripheral surface 63e1 of the small-diameter section 63e of the tubular body section 63a. In addition, the hole of the first seal member 64 is elastically deformed and in intimate contact with the outer peripheral surface of the signal terminal 61. With this configuration, moisture entering from the X2 side of the signal terminal 61, which is exposed inside the tubular shell 63, can be prevented from proceeding to and entering the X1 side of the signal terminal 61, the tubular shell 63, and the holder 62.

The connector 100 also includes the second seal member 66 having the first outer protrusion 66a, the first inner protrusion 66c, the second outer protrusion 66b, and the second inner protrusion 66d. The first outer protrusion 66a of the second seal member 66 is in intimate contact with the fifth inner peripheral surface 65d1 of the intermediate annular section 65d of the shield member 65, and the second outer protrusion 66b is in intimate contact with the first recess surface 14f1 of the recess 14f of the second tubular wall 14c of the housing 10. Further, both the first inner protrusion 66c and the second inner protrusion 66d of the second seal member 66 are in intimate contact with the outer peripheral surface of the first large-diameter section 63f of the tubular shell 63. This configuration allows the second seal member 66 to be fixed to the tubular shell 63, and can prevent moisture entering from a gap between the insertion section 15 of the housing 10 and the tubular body section 63a of the tubular shell 63 from proceeding to and entering the X1 side of the tubular shell 63 and the shield member 65.

Further, by providing the second seal member 66, moisture entering in the opposite direction, i.e., entering from a gap between the X1 side of the tubular shell 63 and the shield member 65 can be prevented from proceeding to and entering the X2 side of the housing 10 and the tubular shell 63.

Furthermore, due to elastic deformation, the projections 66e formed on the X1-side surface of the second seal member 66 are in intimate contact with the X2-side surface of the first flange section 63b of the tubular shell 63, and the projections 66e formed on the X2-side surface are in intimate contact with the second recess surface 14f2 of the recess 14f of the housing 10 (see FIG. 2). Therefore, even if the second seal member 66 repeatedly expands and contracts under high-temperature and low-temperature conditions, intimate contact of the second seal member 66 with the shield member 65, the housing 10, and the tubular shell 63 can be maintained. Moreover, with this configuration, the restoring force of the second seal member 66 acts in the X1 direction since the projections 66e on the X2 side of the second seal member 66 are supported by the second recess surface 14f2. Accordingly, even if the second crimp section 65h loosens, the second seal member 66 constantly presses the first flange section 63b against the second crimp section 65h. Thus, electrical connection between the tubular shell 63 and the shield member 65 can be maintained. As a result, stable shielding characteristics can be achieved.

Furthermore, in the connector 100, moisture ingress can be suppressed simply by attaching the first seal member 64 and the second seal member 66 to the tubular shell 63 during assembly. Therefore, compared to sealing by potting or similar methods, moisture ingress can be suppressed with fewer person-hours.

### Method for Manufacturing Connector

Next, a method of manufacturing the connector 100 will be described. The signal terminal 61 of the connector 100 is formed by machining or the like, after which the holder 62 is formed by insert molding and integrated with the signal terminal 61. The tubular shell 63 is formed by machining. The first seal member 64 is formed by molding.

Next, the annular plate-shaped first seal member 64 is attached from the X1 side of the tubular shell 63 in such a manner as to come into contact with the support section 63j. At this time, the outer peripheral surface of the first seal member 64 is elastically deformed and in intimate contact with the third inner peripheral surface 63e1 of the small-diameter section 63e. Then, the holder 62 into which the signal terminal 61 is inserted is attached from the X1 side of the tubular shell 63. At this time, the four press-fit sections 62b of the holder 62 undergo elastic deformation and come into intimate contact with the third inner peripheral surface 63e1. The holder 62 is inserted until the stopper 62a comes into contact with the third step 63i (see FIG. 2). At this time, the signal terminal 61 passes through the first seal member 64. As a result, the inner peripheral surface of the first seal member 64 undergoes elastic deformation in a diameter-expanding direction and comes into intimate contact with the signal terminal 61. The first seal member 64 also undergoes elastic deformation in the X direction such that the X1-side surface of the first seal member 64 comes into intimate contact with the holder 62, and the X2-side surface comes into intimate contact with the X1-side surface of the support section 63j. Note that the holder 62 may come into contact with the X1-side surface of the first seal member 64 without elastic deformation, or a gap may be present between the holder 62 and the X1-side surface of the first seal member 64.

Next, riveting is performed to crush the second step 63h of the tubular shell 63 radially inward over the entire circumference, thereby forming the first crimp section 63k (see FIG. 2). As a result, the holder 62 (stopper 62a) is clamped between the third step 63i and the second step 63h. Consequently, the holder 62 (the signal terminal 61) is held and fixed to the tubular shell 63, and the holder 62 does not come off the tubular shell 63 in the X1 direction.

Next, the second seal member 66 is fitted between the first flange section 63b and the second flange section 63c of the tubular shell 63. At this time, the first inner protrusion 66c and the second inner protrusion 66d of the second seal member 66 are elastically deformed radially outward and are in intimate contact with the outer peripheral surface of the first large-diameter section 63f of the tubular shell 63.

The shield member 65 is formed by machining. The outer diameter of the intermediate annular section 65d of the shield member 65 is smaller than the outer diameter of the upper annular section 65e. That is to say, the intermediate annular section 65d of the shield member 65 is formed as an undercut shape for the upper annular section 65e.

Next, the housing 10 is formed by insert molding on the outer surface of the shield member 65. As a result, the housing 10 comes into intimate contact with the X2-side surface of the lower annular section 65c of the housing contact section 65a, the outer peripheral surface and X2-side inner peripheral surface of the intermediate annular section 65d, and the outer peripheral surface, both surfaces perpendicular to the X direction, the four recessed grooves 65f, and the inner peripheral surface of the upper annular section 65e of the shield member 65.

In particular, the holding section 14a1 of the housing 10 is in intimate contact over the entire outer peripheral surface of the intermediate annular section 65d, which has an undercut shape for the upper annular section 65e. Thus, the shield member 65 is held with respect to the housing 10 and does not come off or move in the X1 direction. Furthermore, since the housing 10 is in intimate contact with the four recessed grooves 65f, the shield member 65 does not move in a rotational direction about the center axis Y with respect to the housing 10.

As described above, in the connector 100 according to the present embodiment, the housing 10 is formed on the shield member 65 using a simple and inexpensive method, i.e., by insert molding. Thus, the shield member 65 can be fixed to the housing 10 in such a manner as not to move in the X1 direction or in a rotational direction about the center axis Y. Furthermore, with the connector 100, there is no need to separately provide a component for locking the shield member 65 to the housing 10, enabling miniaturization of the connector 100.

Next, the tubular body section 63a of the tubular shell 63, to which the signal terminal 61 and the holder 62 are attached, is inserted from the X1 side of the shield member 65, on which the housing 10 has been formed, through the through-hole 65i of the shield member 65, the internal space 14e of the base section 14 of the housing 10, and the internal space 15c of the insertion section 15, until the tubular body section 63a reaches the fitting section 16. At this time, the tubular shell 63 is inserted in such a manner as to set the position of the tubular shell 63 relative to the housing 10 such that the center axis Y of the housing 10 coincides with the axis of the signal terminal 61 using an assembly jig or manufacturing device.

As mentioned above, the inner diameters of the sixth inner peripheral surface 65b1 of the flange section 65b and the fourth inner peripheral surface 65c1 of the lower annular section 65c of the shield member 65 are slightly larger than the outer diameter of the first flange section 63b of the tubular shell 63. Therefore, the first flange section 63b of the tubular shell 63 is smoothly inserted along the sixth inner peripheral surface 65b1 and the fourth inner peripheral surface 65c1. The tubular shell 63 is inserted until the X2-side surface of the first flange section 63b comes into contact with the fourth step 65d2 of the shield member 65. This causes the tubular shell 63 to be locked and positioned with respect to the shield member 65 and the housing 10. At this time, the X2-side projections 66e of the second seal member 66 are pressed against the second recess surface 14f2 of the recess 14f of the housing 10 while the X1-side projections 66e are in contact with the first flange section 63b, causing the second seal member 66 to be compressed and elastically deformed along the X direction. At this time, the X2-side surface of the second flange section 63c of the tubular shell 63 is in contact with or close to the first step 15b of the housing 10. Furthermore, at this time, the first outer protrusion 66a of the second seal member 66 undergoes elastic deformation radially inward and comes into intimate contact with the fifth inner peripheral surface 65d1 of the intermediate annular section 65d of the shield member 65. The second outer protrusion 66b also undergoes elastic deformation radially inward and comes into intimate contact with the first recess surface 14f1 of the recess 14f of the housing 10. With the X2-side surface of the first flange section 63b of the tubular shell 63 in contact with the fourth step 65d2 of the shield member 65, the first flange section 63b is fully accommodated inside the shield member 65 in the X direction. As a result, the X1-side edge of the sixth inner peripheral surface 65b1 of the flange section 65b of the shield member 65 does not face the first flange section 63b in the radial direction around the entire circumference.

Lastly, the X1-side edge of the sixth inner peripheral surface 65b1 of the flange section 65b of the shield member 65 is crushed radially inward to form the second crimp section 65h. The first flange section 63b of the tubular shell 63 is thereby clamped by the second crimp section 65h and the fourth step 65d2 and is fixed to the shield member 65, establishing electrical connection between the tubular shell 63 and the shield member 65. Note that the second crimp section 65h may be formed over the entire circumference of the inner peripheral edge of the flange section 65b, or may be formed discretely in the circumferential direction as long as the fixing strength of the tubular shell 63 to the shield member 65 and the electrical connection between the tubular shell 63 and the shield member 65 are ensured.

### Other Embodiments

(1) In the above embodiment, the recessed grooves 65f are formed on the X2-side surface of the upper annular section 65e. However, the invention is not limited thereto. Instead of, or in addition to, the X2-side surface of the upper annular section 65e, the recessed grooves 65f may be formed on at least one of the outer peripheral surface of the upper annular section 65e, the outer peripheral surface of the intermediate annular section 65d, or the X2-side surface of the lower annular section 65c. Even when the recessed grooves 65f are formed at such locations, the shield member 65 does not move in a rotational direction about the center axis Y with respect to the housing 10.

(2) In the above embodiment, both the intermediate annular section 65d and the upper annular section 65e have an annular shape. However, the invention is not limited thereto. At least either the intermediate annular section 65d or the upper annular section 65e may be provided with a D-cut (an example of a cutout section; not shown) by cutting away a portion of the outer edge of the annular shape instead of forming the recessed grooves 65f. The intermediate annular section 65d and/or the upper annular section 65e having the D-cut still has a shape included in annular shapes. By providing the D-cut, the shield member 65 can be prevented from moving in a rotational direction about the center axis Y with respect to the housing 10 even without providing the recessed grooves 65f.

(3) In the above embodiment, the second seal member 66 is compressed in the X direction and elastically deformed, with the second seal member 66 attached to the tubular shell 63. However, the invention is not limited thereto. With the second seal member 66 attached to the tubular shell 63, the second seal member 66 need not necessarily be elastically deformed in the X direction. In this case, the distance between the X2-side surface of the first flange section 63b of the tubular shell 63 and the second recess surface 14f2 of the recess 14f of the housing 10 is set to be the same as, or slightly longer than, the length of the second seal member 66 in the X direction. Note that, in this case, no restoring force is generated in the second seal member 66.

The present disclosure is applicable to connectors.

### Reference Signs List

10: Housing
14f2: Second recess surface (support surface)
61: Signal terminal (terminal)
62: Holder
63: Tubular shell
63a: Tubular body section
63b: First flange section
63c: Second flange section
63e1: Third inner peripheral surface (tubular inner peripheral surface)
63i: Third step (step section)
63k: First crimp section (hold crimp section)
64: First seal member (inner seal member)
65: Shield member
65b: Flange section (connection section)
65b1: Sixth inner peripheral surface (annular inner peripheral surface)
65d: Intermediate annular section (second annular section)
65d2: Fourth step (lock section)
65e: Upper annular section (first annular section)
65f: Recessed groove (cutout section)
65h: Second crimp section (connection crimp section)
66: Second seal member (outer seal member)
66a: First outer protrusion
66b: Second outer protrusion
66c: First inner protrusion
66d: Second inner protrusion
100: Connector

What is claimed is:

1. A connector to which a coaxial cable is electrically connectable, comprising:
a bar-shaped terminal having electrical conductivity and electrically connectable to an internal conductor of the coaxial cable;
an insulating holder supporting the terminal inserted therein, in such a manner as to be coaxial with an axis of the terminal;
an electrically conductive tubular shell fitted onto the holder in such a manner as to be coaxial with the axis and electrically connectable to an external conductor of the coaxial cable,
the tubular shell having:
a tubular body section covering the holder; and
an annular first flange section extending radially outward from the tubular body section;
an electrically conductive shield member in contact with the tubular shell and configured to block an external electromagnetic wave, the shield member having a cylindrical shape demarcating a through-hole through which the tubular body section passes, and having a connection section in contact with and electrically connected to the first flange section;
an insulating housing disposed in intimate contact with the shield member; and
an insulating outer seal member fitted onto the tubular shell and configured to suppress ingress of water into the shield member,
the outer seal member having:
a first outer protrusion and a second outer protrusion each having an annular shape and protruding radially outward, and
a first inner protrusion and a second inner protrusion each having an annular shape and protruding radially inward,
wherein the outer seal member is elastically deformed in a radial direction in such a manner that the first outer protrusion is in intimate contact with the shield member, the second outer protrusion is in intimate contact with the housing, and the first inner protrusion and the second inner protrusion are in intimate contact with the tubular shell.

2. The connector according to claim 1,
wherein the housing has a support surface perpendicular to the axis, and
the outer seal member is disposed in a state of being compressed and elastically deformed by the first flange section and the support surface along an extension direction of the axis.

3. The connector according to claim 1,
wherein the shield member has:
a first annular section having an annular shape and demarcating a portion of the through hole, and
a second annular section having an annular shape, disposed closer to the connection section in an extension direction of the axis than the first annular section, and having an outer diameter smaller than an outer diameter of the first annular section, and
the housing is in intimate contact with at least an outer side surface of the first annular section and an outer side surface of the second annular section.

4. The connector according to claim 1,
wherein the shield member has a cutout section, and
the housing is in intimate contact with the cutout section.

5. The connector according to claim 1,
wherein the shield member has:
an annular lock section protruding radially inward relative to an annular inner peripheral surface of the connection section, and
a connection crimp section on the annular inner peripheral surface of the connection section, and
the first flange section of the tubular shell is electrically connected to the shield member by being clamped by the lock section and the connection crimp section.

6. The connector according to claim 1,
wherein the tubular shell has:
a step section in which a tubular inner peripheral surface of the tubular body section has an expanded diameter in a vicinity of the first flange section, and
a hold crimp section on the tubular inner peripheral surface of the tubular body section, and
the holder is held by the tubular shell by being clamped by the step section and the hold crimp section.

7. The connector according to claim 1, further comprising:
an inner seal member elastically deformed and disposed in intimate contact with a tubular inner peripheral surface of the tubular body section and an outer peripheral surface of the terminal.
